(19) United States
(12) Patent Application Publication
(10) Pub. No.: US 2011/0130476 A1
(43) Pub. Date: Jun. 2, 2011

(54) FLAME RETARDED RIGID POLYURETHANE FOAMS AND RIGID POLYURETHANE FOAM FORMULATIONS

(75) Inventors: Hoover B. Chew, Summerville, SC (US); Ravindra R. Joshi, Stevenson Ranch, CA (US); Arthur G. Mack, Prairieville, LA (US); Augusto C. Ibay, Acworth, GA (US)

(73) Assignee: Albemarle Corporation, Baton Rouge,, LA (US)

(21) Appl. No.: 12/672,474

(22) PCT Filed: Aug. 6, 2008
(86) PCT No.: PCT/US08/72331

§ 371 Date: Feb. 5, 2010

Related U.S. Application Data
(60) Provisional application No. 60/954,510, filed on Aug. 7, 2007.

(51) Int. Cl. C08K 5/5357; C08K 5/523; C08J 9/35

(52) U.S. Cl. 521/108

(57) ABSTRACT

The present invention relates to flame retarded polyurethane or polyisocyanurate foam formulations, flame retardant additives suitable for use therein, and flame retarded foams made therefrom.

### FIELD OF THE INVENTION

The present invention relates to flame retarded rigid polyurethane foam formulations, flame retardant additives suitable for use therein, and flame retarded foams made therefrom.

### BACKGROUND OF THE INVENTION

Rigid polyurethane foam are most typically produced using a cast process or spray process. The cast process is generally utilized for block foam production, continuous double band lamination (“DBL”), and discontinuous panel production (“DCP”), and block foam is typically produced by known discontinuous production or continuous rigid slab-stock production methods. If necessary for specialty products, the block foam is cut after production to the required shape, and is typically glued to facings to make the finished specially product. Such products find use in, for example, the building industry, in truck insulation, and in the form of “half shells” for pipe insulation.

Double band lamination is a continuous panel production process with both sides of the panel laminated with flexible or rigid facing materials. The polyurethane foam core is sandwiched between those facings and applied as insulation for floors, walls and roofs. Sandwich panels with a rigid metal facing are structural building elements and can be applied as roof and wall construction elements such as cold-store panels, garage doors, refrigerated trucks, and for similar uses. Sandwich panels with non-metal rigid facing, e.g., gypsum board or wood, are used in the manufacture of prefabricated houses or other building structures.

Because of the widespread use of rigid polyurethane foams, much research has been done on providing flame retardancy to polyurethane/polyisocyanurate foams. To this end, a myriad of flame retardants have been used and proposed to provide flame retardant properties to rigid polyurethane foams. However, even with the available flame retardants the industry has increasingly requested flame retardants that outperform or have more favorable characteristics than those currently available.

### SUMMARY OF THE INVENTION

The present invention relates to a flame retardant additive comprising: a) at least one, in some embodiments only one, phosphorous-containing flame retardant; and b) at least one, in some embodiments only one, alkylated triaryl phosphate ester, preferably isopropylphenyl diphenyl phosphate, wherein a) is present in an amount of less than about 30 wt. %, based on the total weight of the flame retardant additive and b) is present in an amount of greater than about 70 wt. %, based on the total weight of the flame retardant additive.

The present invention also relates to a rigid polyurethane foam formulation comprising a) at least one, in some embodiments only one, phosphorous-containing flame retardant; and b) at least one, in some embodiments only one, alkylated triaryl phosphate ester, preferably isopropylphenyl diphenyl phosphate; c) at least one, in some embodiments only one, i) isocyanate; ii) polyol, or combinations of i) and ii); and d) at least one, in some embodiments only one, blowing agent, wherein a) is present in an amount of less than about 30 wt. %, based on the total weight of a) and b), and b) is present in an amount of greater than about 70 wt. %, based on the total weight of a) and b).

The present invention also relates to a process for forming a rigid flame retarded polyurethane foam comprising combining or bringing together a) at least one, in some embodiments only one, phosphorous-containing flame retardant; and b) at least one, in some embodiments only one, alkylated triaryl phosphate ester, preferably isopropylphenyl diphenyl phosphate; c) at least one, in some embodiments only one, i) isocyanate; ii) polyol, or combinations of i) and ii); and d) at least one, in some embodiments only one, blowing agent, in the presence of at least one, in some embodiments only one, catalyst, wherein a) is present in an amount of less than about 30 wt. %, based on the total weight of a) and b), and b) is present in an amount of greater than about 70 wt. %, based on the total weight of a) and b), and wherein the flame retarded polyurethane/polyisocyanurate foam thus formed meets or exceeds the requirements of California Technical Bulletin 117 part A and D.

### DETAILED DESCRIPTION OF THE INVENTION

The inventors hereof have discovered that the use of the flame retardant additives described herein, can provide rigid flame retarded polyurethane foams that meet or exceeds the requirements of California Technical Bulletin 117 part A and D.

### Flame Retardant Additive

The flame retardant additives of the present invention comprise a) at least one, in some embodiments only one, phosphorous-containing flame retardant; and b) at least one, in some embodiments only one, alkylated triaryl phosphate ester.

Generally, the flame retardant additives of the present invention contain less than about 30 wt. %, typically in the range of from about 1 to about 30 wt. %, of a) and greater than about 70 wt. %, typically in the range of from about 70 to about 99 wt. %, of b), all based on the total weight of the flame retardant additive. In some embodiments, the flame retardant additives of the present invention contain in the range of from about 5 to about 30 wt. % of a) and in the range of from about 70 to about 95 wt. % of b). In an exemplary embodiment, the flame retardant additives of the present invention contain in the range of from about 5 to about 15 wt. % of a) and in the range of from about 85 to about 95 wt. % of b).

The flame retardant additives of the present invention can be characterized as having a phosphorus content in the range of from about 5 to about 15 wt. %, based on the total weight of the flame retardant additive. In some embodiments, the flame retardant additives of the present invention can be characterized as having a phosphorus content in the range of from about 8 to about 15 wt. %, preferably in the range of from about 8 to about 12 wt. %, both on the same basis.

The flame retardant additives of the present invention can also be characterized as having a viscosity at 25° C., in the range of from about 100 to about 2000 cP. In some embodiments, the flame retardant additives of the present invention can be characterized as having a viscosity in the range of from about 100 to about 1000 cP, preferably in the range of from about 400 to about 600 cP. The low viscosity of the present flame retardant additives make the especially effective in rigid foam formulations because the low viscosity allows for better dispersion in the rigid foam formulations, thus allowing for more effective foams. For example, a poorly dispersed flame retardant could negatively effect the mechanical properties of the foam, as is well-known in the art.

The inventors hereof have unexpectedly discovered that by utilizing levels of a) as low as described above, flame retarded rigid polyurethane foams that meet or exceeds the requirements of California Technical Bulletin 117 part A and D can be provided. This is a desirable quality because phosphorous-containing flame retardants currently used in polyurethane, which can be used in some embodiments of the present invention, are considered chemical weapons precursors, thus their shipping, use, etc., and distribution could prove problematic and expensive. However, the inventors hereof have discovered that phosphorous-containing flame retardant levels within the above described ranges, in some embodiments in the range of from about 5 to about 15 wt. %, alleviates some of the problems associated with having a component of the flame retardant additive considered a chemical weapons precursor. While heretofore levels within this range were not contemplated, the inventors hereof have unexpectedly discovered that phosphorous-containing flame retardant levels within these ranges can still provide for flame retarded polyurethane/polyisocyanurate foams that meet or exceeds the requirements of California Technical Bulletin 117 part A and D.

### Component a)

The phosphorous-containing flame retardant used herein can be selected from any phosphorous flame retardant, preferably those phosphorous flame retardants having a phosphorous content, as determined by P-NMR or ICP, in the range of from about 10 to about 30 wt. %, preferably in the range of from about 15 to about 25 wt. %, more preferably in the range of from about 18 to about 21 wt. %, all based on the total weight of the phosphorous flame retardant. In some embodiments, the phosphorous-containing flame retardant is a phosphate, in other embodiments a phosphite, and in still other embodiments, a phosphonate. The phosphorus-containing flame retardant can be cyclic or linear, preferably cyclic. In an exemplary embodiment, the phosphorous-containing flame retardant used herein is a cyclic phosphonate. In some embodiments, the cyclic phosphonate contains at least dimers and monomers, typically in the range of from about 50 to about 70 wt. % monomer and in the range of from about 15 to about 25 wt. % dimer, both based on the total weight of the cyclic phosphonate. In these embodiments, the remainder of the cyclic phosphonate is typically trimers, etc. that have a higher molecular weight than the dimers. In preferred embodiments, the monomers are CAS registration number 41203-81-0, and the dimers are CAS registration number 42595-45-9.

### Component b)

The alkylated triaryl phosphate ester used herein can be selected from any alkylated triaryl phosphate ester. In preferred embodiments, the alkylated triaryl phosphate ester used herein is a mixture of isopropylated triphenyl phosphate esters. The alkylated triaryl phosphate ester can comprise in the range of from about 20 to about 50 wt. %, based on the total weight of the alkylated triaryl phosphate ester, isopropylphenyldiphenylphosphate, preferably in the range of from about 20 to about 40 wt. %, more preferably in the range of from about 30 to about 40 wt. %, on the same basis. The mixture alkylated triaryl phosphate ester can comprise in the range of from about 20 to about 40 wt. %, based on the total weight of the alkylated triaryl phosphate ester, di(isopropylphenylphenyl)phenylphosphate, preferably in the range of from about 20 to about 35 wt. %, more preferably in the range of from about 20 to about 30 wt. %, on the same basis. The alkylated triaryl phosphate ester can comprise in the range of from about 1 to about 15 wt. %, based on the total weight of the alkylated triaryl phosphate ester, tri(isopropylphenyl)phosphate, preferably in the range of from about 5 to about 15 wt. %, on the same basis. The alkylated triaryl phosphate ester used herein can comprise in the range of from about 0 to about 50 wt. %, triphenyl phosphate, based on the total weight of the alkylated triaryl phosphate ester, preferably, in the range of from about 10 to about 50 wt. %, more preferably in the range of from about 20 to about 40 wt. %, triphenyl phosphate, most preferably in the range of from about 20 to about 35 wt. %, triphenyl phosphate, all on the same basis. In an exemplary embodiment, the alkylated triaryl phosphate ester is a mixture of isopropylated triphenyl phosphate esters comprising at least two of, preferably at least three of, more preferably all of: i) isopropylphenyldiphenylphosphate; ii) di(isopropylphenylphenyl)phenylphosphate; iii) tri(isopropylphenyl)phosphate; and iv) triphenyl phosphate. In this particular embodiment, the amount of i) isopropylphenyldiphenylphosphate; ii) di(isopropylphenylphenyl)phenylphosphate; iii) tri(isopropylphenyl)phosphate; and iv) triphenyl phosphate in the mixture of isopropylated triphenyl phosphate esters is as described in this paragraph, including preferred embodiments, e.g., for i) isopropylphenyldiphenylphosphate, in the range of from about 20 to about 50 wt. %, based on the total weight of the alkylated triaryl phosphate ester, isopropylphenyldiphenylphosphate, preferably in the range of from about 20 to about 40 wt. %, etc.

### Use as a Flame Retardant

The flame retardant additives of the present are useful in providing flame retardancy to rigid polyurethane foams. Typically, the flame retardant additives will be included as one of various additives employed in the polyurethane foam formation process and will be employed using typical polyurethane foam formation conditions. Anyone unfamiliar with the art of forming polyurethanes or polyurethane foams may refer to, for example U.S. Pat. Nos. 3,954,684; 4,209,609; 5,356,943; 5,563,180; and 6,121,338, and the references cited therein.

Thus, in some embodiments, the present invention relates to a rigid polyurethane foam formulation comprising a flame retardant additive according to the present invention, typically a flame retarding amount of a flame retardant additive according to the present invention; at least one, in some embodiments only one, isocyanate, polyol or combination thereof; and at least one, in some embodiments only one, blowing agent, and rigid polyurethane foams formed therefrom. Blowing agents suitable for use herein include water, a volatile hydrocarbon, halocarbon, or halohydrocarbon, or mixtures of two or more such materials.

By a flame retarding amount of the flame retardant additives of the present invention, it is meant that amount sufficient to meet or exceed the test standards set forth in California Technical Bulletin 117 part A and D. Generally, this is in the range of from about 5 to about 25 phr of the flame retardant additive. In preferred embodiments, a flame retarding amount is to be considered in the range of from about 5 to about 20 phr, more preferably in the range of from about 5 to about 15 phr, most preferably in the range of from about 10 to about 15 phr of the flame retardant additive.

The isocyanate used in the present invention can be selected from any of those known in the art to be effective in producing rigid polyurethane foams. Thus, organic polyisocyanates which may be employed include aromatic, aliphatic, and cycloaliphatic polyisocyanates and combinations thereof. Representative of these types are the diisocyanates such as m-phenylene diisocyanate, 2,4-toluene diisocyanate, 2,6-toluene diisocyanate, mixtures of 2,4- and 2,6-toluene diisocyanate, hexamethylene diisocyanate, tetramethylene diisocyanate, cyclohexane-1,4-diisocyanate, hexahydrotoluene diisocyanate (and isomers), naphthalene-1,5-diisocyanate, 1-methoxyphenyl-2,4-diisocyanate, 4,4′-diphenylmethane diisocyanate, 4,4′-biphenylene diisocyanate, 3,3′-dimethoxy-4,4′-biphenyl diisocyanate, 3,3′-dimethyl-4,4′-biphenyl diisocyanate and 3,3′-dimethyldiphenylmethane-4,4′-diisocyanate; the triisocyanates such as 4,4′,4″-triphenylmethane triisocyanate, and toluene 2,4,6-triisocyanate; and the tetraisocyanates such as 4,4′-dimethyldiphenylmethane-2,2′,5,5′-tetraisocyanate and polymeric polyisocyanates such as polymethylene polyphenylene polyisocyanate. Especially useful due to its availability and properties is toluene diisocyanate.

Polyols suitable for use herein can be selected from any polyols known in the art to be effective at producing rigid polyurethane foams, in preferred embodiments a polyester polyol. Thus individual or mixtures of polyols with hydroxyl values in the range of from 150 to 850 mg KOH/g, and preferably in the range of from 200 to 600 mg KOH/g, and hydroxyl functionalities in the range of from 2 to 8 and preferably in the range of from 3 to 8 are used. Suitable polyols meeting these criteria have been fully described in the literature, and include reaction products of (a) alkylene oxide such as propylene oxide and/or ethylene oxide, with (b) initiators having in the range of from 2 to 8 active hydrogen atoms per molecule. Suitable initiators include, for example, diols (e.g., diethylene glycol, bisphenol-A), polyesters (e.g., polyethylene terephthalate), triols (e.g., glycerine), novolac resins, ethylenediamine, pentaerythritol, sorbitol, and sucrose. Other usable polyols include polyesters prepared by the condensation reaction of appropriate proportions of glycols and higher functionality polyols with dicarboxylic or polycarboxylic acids. The polyether polyols can be mixed with polyester types. Other polyols include hydroxyl-terminated polythioethers, polyamides, polyesteramides, polycarbonates, polyacetals and polysiloxanes.

In addition to these components, the rigid polyurethane foam formulations can contain any other component known in the art and used in the formation of rigid polyurethane foams. These other components are well known to those of ordinary skill in the art. For example, the rigid polyurethane foam formulations can contain i) surfactants, ii) antioxidants, i) diluents, iv) chain extenders or cross linkers, v) synergists, preferably melamine; and vi) plasticizers. These optional components are well known in the art and the amount of these optional components is conventional and not critical to the instant invention. For example, non-limiting examples of diluents such as low viscosity liquid C₁₋₄ halocarbon and/or halohydrocarbon diluents in which the halogen content is 1-4 bromine and/or chlorine atoms can also be included in the compositions of this invention. Non-limiting examples of such diluents include bromochloromethane, methylene chloride, ethylene dichloride, ethylene dibromide, isopropyl chloride, n-butyl bromide, sec-butyl bromide, n-butyl chloride, sec-butyl chloride, chloroform, perchloroethylene, methyl chloroform, and carbon tetrachloride.

It should be noted that these and other ingredients that can be used in the polyurethane/polyisocyanurate foam formulations of the present invention, and the proportions and manner in which they are used are reported in the literature.

In the practice of the present invention, the rigid polyurethane foam formulations can be combined with a catalyst, or the individual components combined in the presence of a catalyst, to form a flame retarded rigid polyurethane foam that meets or exceeds the test standards set forth in California Technical Bulletin 117 part A and D. Non-limiting examples of catalysts suitable for use in forming the rigid polyurethane foams include gel catalysts, blow catalysts, balanced gel/blow catalysts, trimerization catalysts, and the like.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount.

The following examples will illustrate the present invention, but are not meant to be limiting in any manner.

### Examples

In order to prove the effectiveness of a flame retardant according to the present invention, foams were prepared with and without a flame retardant according to the present invention. The flame retardant used in these examples was a mixture of about 10 wt. % of a commercially available cyclic phosphonate flame retardant sold under the tradename Amgard CU, and about 90 wt. % isopropyl diphenyl phosphate ester.

Foam Preparation: The polyols, flame retardant, cyclopentane, silicone surfactant, dimethylcyclohexylamine, and water were weighed into a one-gallon-sized jar in the amounts indicated in the Table, which was then capped, shaken, and rolled for at least one hour to obtain a homogeneous blend. A portion of this blend and the required amount of polymeric MDI based on the amount of the blend were then weighed into a one-gallon “chicken bucket.” The contents of the cup were then mixed at 2000 rpm using a bow-tie agitator for 20 seconds and immediately poured into a polyethylene sheet-lined mold. The mold was closed and foam was allowed to rise in the mold. Meanwhile, the reactivity profile was obtained from the remaining material in the chicken bucket. For this system, the typical reactivity profile was 35 sec for creme time, 1 min 5 sec for gel time, 1 min 35 sec for tack free time, and 2 min 5 sec for free rise time.

TABLE
Comparison of Rigid Polyurethane Pour Foam with and without
a flame retardant according to the present invention.

| | According to | |
|---|---|---|
| | the Present | |
| | Invention | Comparative |
| Polyester Polyol (OH = 307) | 36.00% | 67.00% |
| (Terate 4020 from Invista) | | |
| Polyether polyol (OH = 490) | 16.20% | 20.20% |
| (Voranol 490 from Dow) | | |
| Flame Retardant | 35.00% | — |
| Cyclopentane | 10.00% | 10.00% |
| (Exxsol 2000 from Exxon) | | |
| Silicone Surfactant | 1.00% | 1.00% |
| (Pelsil 9900 from Pelron) | | |
| DMCHA (Polycat 8 from | 0.50% | 0.50% |
| Air Products) | | |
| Water | 1.30% | 1.30% |
| Polymeric MDI (31.4% | 110 | 110 |
| NCO) Index (PAPI-27 from | | |
| Dow) | | |
| A/B wt. Ratio | 0.71 | 1.01 |
| PROPERTIES | | |
| Density (lb/in³) | 2.37 | 2.01 |
| Flame Spread Index* | 33.4 | 49.7 |
| Smoke Index* | 286 | 354 |

*Predicted ASTM E−84 values based on Cone Calorimeter results.
DMCHA = dimethylcyclohexylamine

1. A rigid polyurethane foam derived from at least one isocyanate, polyol, or mixture thereof; at least one blowing agent; and a flame retardant additive wherein said flame retardant additive contains:
a) at least one cyclic phosphonate flame retardant;
b) at least one alkylated triaryl phosphate ester, and optionally
c) one or more i) surfactants, ii) antioxidants, iii) diluents, iv) chain extenders or cross linkers, v) synergists; and vi) plasticizers,
wherein a) is present in an amount of less than about 30 wt. %, based on the total weight of a) and b), and b) is present in an amount of greater than about 70 wt. %, based on the total weight of a) and b), and wherein the rigid polyurethane foam meets or exceeds the requirements of California Technical Bulletin 117 part A and D.

2. (canceled)

3. The rigid polyurethane foam according to claim 1 wherein the cyclic phosphonate contains in the range of from about 50 to about 70 wt. % monomer and in the range of from about 15 to about 25 wt. % dimer, both based on the total weight of the cyclic phosphonate.

4. The rigid polyurethane foam according to claim 1 wherein the alkylated triaryl phosphate ester is a mixture of isopropylated triphenyl phosphate esters comprising at least one of: i) isopropylphenyldiphenylphosphate; ii) di(isopropylphenyl)phenylphosphate; iii) tri(isopropylphenyl)phosphate; and iv) triphenyl phosphate.

5. (canceled)

6. The rigid polyurethane foam according to claim 3 wherein the monomers are CAS registration number 41203-81-0, and the dimers are CAS registration number 42595-45-9.

7-9. (canceled)

10. A process for forming a flame retarded polyurethane or polyisocyanurate foam comprising combining or bringing together:
a) at least one cyclic phosphonate flame retardant;
b) at least one, alkylated triaryl phosphate ester;
c) at least one isocyanate, polyol, or mixture thereof;
d) at least one blowing agent; and
optionally
e) one or more i) surfactants, ii) antioxidants, iii) diluents, iv) chain extenders or cross linkers, v) synergists; and vi) plasticizers,
wherein a) is present in an amount of less than about 30 wt. %, based on the total weight of a) and b), and b) is present in an amount of greater than about 70 wt. %, based on the total weight of a) and b); the rigid polyurethane foam meets or exceeds the requirements of California Technical Bulletin 117 part A and D, and a)-d), and optionally e), are combined in the presence of at least one catalyst.

11. (canceled)

12. The process according to claim 10 wherein the cyclic phosphonate contains in the range of from about 50 to about 70 wt. % monomer and in the range of from about 15 to about 25 wt. % dimer, both based on the total weight of the cyclic phosphonate.

13. The process according to claim 10 wherein the alkylated triaryl phosphate ester is a mixture of isopropylated triphenyl phosphate esters comprising at least one of: i) isopropylphenyldiphenylphosphate; ii) di(isopropylphenyl)phenylphosphate; iii) tri(isopropylphenyl)phosphate; and iv) triphenyl phosphate.

14. (canceled)

15. The process according to claim 12 wherein the monomers are CAS registration number 41203-81-0, and the dimers are CAS registration number 42595-45-9.

16. (canceled)

17. The process according to claim 13 wherein the amount of said at least one of i)-iv) in said mixture of isopropylated triphenyl phosphate esters is: i) in the range of from about 20 to about 50 wt. %, isopropylphenyldiphenylphosphate; ii) in the range of from about 20 to about 40 wt. %, based on the total weight of the alkylated triaryl phosphate ester, di(isopropylphenyl)phenylphosphate; iii) in the range of from about 1 to about 15 wt. %, tri(isopropylphenyl)phosphate, iv) in the range of from about 0 to about 50 wt. %, triphenyl phosphate, all based on the total weight of the mixture of isopropylated triphenyl phosphate esters.

18-19. (canceled)

20. The process according to claim 10 wherein a) is present in an amount in the range of from about 5 to about 25 phr.

21. A molded or extruded article made from the flame retarded polyurethane foam according to claim 10.
